(19) United States
(12) Patent Application Publication
(10) Pub. No.: US 2007/0078875 A1
(43) Pub. Date: Apr. 5, 2007

(54) Semantically complete templates

(75) Inventors: Nikhil Kothari, Sammamish, WA (US); Bertrand Le Roy, Bellevue, WA (US); Shanku Shivabrata Niyogi, Sammamish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/319,288

(22) Filed: Dec. 27, 2005

Related U.S. Application Data
(60) Provisional application No. 60/716,366, filed on Sep. 12, 2005.

(51) Int. Cl. G06F 7/00

(52) U.S. Cl. 707/101

(57) ABSTRACT

A template includes a template schema section that defines the overall structure of the final rendering of a control and/or the content of the control. The template may further include a template behavior section defining custom behavior of the control. The template behavior section may reference schema elements defined in the template schema section and specify the custom behavior of the control with references to the elements.

### CROSS-REFERENCE TO RELATED APPLICATION

This application claims the benefit of U.S. Provisional Patent Application No. 60/716,366, filed on Sep. 12, 2005, titled “SEMANTICALLY COMPLETE TEMPLATES,” the disclosure of which is hereby expressly incorporated by reference, and the filing date of which is hereby claimed under 35 U.S.C. § 119(e).

### BACKGROUND

Generally, Web user interfaces are often built up to visualize data in a structured format. A common occurrence in building Web user interfaces is to repeat a piece of user interface for each record in a data source, such as a table of data. This type of repetition is usually accomplished using a templating mechanism, where a template defines the layout and content of the piece of user interface, which is then repeated per record in the data source by a templated control containing the template. During execution time, the templated control enumerates over the records in the data source to build the overall user interface. The templated control may also provide mechanisms for customizing the template and the overall user interface.

However, a template built using the above-described conventional templating mechanism typically defines only the content within an overall user interface structure that is generated by the templated control. For example, the template may only define the content of a table cell, while the templated control, such as a repeater, generates the layout of the table. As a result, the template independently is a fragment of the overall user interface and is incomplete by itself. For example, the template cannot be used directly to preview the overall user interface. Nor can the template be designed independently from the templated control.

Using such a conventional templating mechanism, a Web designer on a Web development team typically has to first put together a screenshot or a static example of the overall user interface. A Web developer then programs the screenshot or the overall user interface design into equivalent templates. Thus, the conventional templating mechanism hinders designability in that it requires a Web developer to program a user interface, rather than allowing a Web designer to complete the design task and put together the user interface.

FIG. 1 displays an exemplary markup language 100 for a templated control Bulleted List Control 102 and an exemplary markup language 101 for another templated control DataList Control 104. The exemplary markup languages 100, 101 illustrate the conventional templating mechanism and its inherent problems. The Bulleted List Control 102 is a typical repeater control, including three templates (HeaderTemplate 106, ItemTemplate 108, FooterTemplate 110) defined to produce a bulleted list. The ItemTemplate 108 is the repeatable content. Each of the three templates is an HTML fragment that is invalid in itself; hence each template cannot be designed or viewed by itself. In addition, the structure of the final rendering of the Bulleted List Control 102 is not immediately apparent in the markup language 100, thus the overall structure of a final rendering of the Control 102 cannot be previewed in a conventional editor such as an HTML editor. As a result, the Web application containing the Control 102 needs to be run and all data rows need to be enumerated before any meaningful representation of the Bulleted List Control 102 can be observed.

Like the Bulleted List Control 102, the DataList Control 104 also incurs the problem that the resultant Web page needs to be run before the representation structure of the DataList Control 104 can be seen. The DataList Control 104 repeats its template ItemTemplate 112 in a tabular row structure separated by a SeparatorTemplate 114 “|”. However, the tabular structure is completely implied and generated only at runtime. This makes it hard to customize the details of the rendering via regular markup languages and Cascading Style Sheets (“CSS”) constructs. A Web designer who is used to constructing a table using well-known HTML constructs cannot independently design the DataList Control 104. Instead, the design from the Web designer needs to be programmed into an equivalent set of templates by a Web developer.

As a result, templates generated by the conventional templating mechanism contain fragmented information. They thus are unable to provide a good design base for a Web designer to complete the user interface design or to allow a Web developer sufficient room to customize the final rendering of the overall user interface.

While specific disadvantages of existing systems have been illustrated and described in this Background Section, those skilled in the art and others will recognize that the subject matter claimed herein is not limited to any specific implementation for solving any or all of the described disadvantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the invention provide semantically complete templates that define the structure of the final rendering of a control and/or the content of the control. Typically, a semantically complete template includes a template schema section that defines the overall representation structure of the final rendering of the control. Preferably, the template schema also provides sample content, i.e., placeholder content, for easy visualization of the final rendering of the control. Such content may be replaced during runtime of the control. The template schema section may also include style options for formatting content and overall representation of the control.

In accordance with another aspect of the invention, the semantically complete template further includes a template behavior section where a developer may define custom behavior of the control. Preferably, the template schema section includes one or more uniquely-identified template schema elements. The template behavior section may reference these uniquely-identified template schema elements to, for example, specify custom behavior of the control with respect to these template schema elements.

Consequently, aspects of the invention supply templates that define overall structure of the final rendering of controls and/or content of the controls. Thus, the templates are semantically complete and can be worked on and viewed independently, without the need to execute the controls in a run-time environment.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating exemplary templates for two exemplary Web user interface controls, created using conventional templating mechanism;

FIG. 2 is a block diagram illustrating an exemplary layout of a semantically complete template, implemented according to aspects of the invention;

FIG. 3 is a block diagram illustrating exemplary template for one exemplary Web user interface control, implemented according to aspects of the invention; and

FIG. 4 is a block diagram illustrating exemplary template for another exemplary Web user interface control, implemented according to aspects of the invention.

### DETAILED DESCRIPTION

The following text illustrates and describes exemplary embodiments of the invention. However, those of ordinary skill in the art will appreciate that various changes can be made therein without departing from the spirit and scope of the invention.

Embodiments of the invention address limitations associated with conventional templating mechanism by generating semantically complete templates that define the overall structure of the final rendering of controls and/or content of the controls. A semantically complete template is a logically complete portion of a Web page and can be worked on and viewed independently. The concepts of a semantically complete template can be implemented in any environment where a template-based customization mechanism for user interface controls is needed or used.

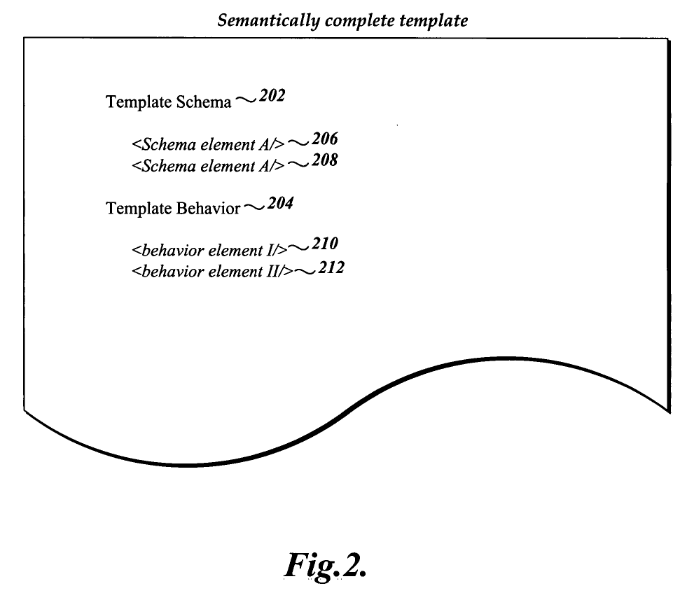

FIG. 2 illustrates an exemplary layout of a semantically complete template 200 implementing aspects of the invention. The semantically complete template 200 contains a template schema section 202 that defines the overall structure of the final rendering of a control represented by the semantically complete template 200. Optionally, the template schema 202 may also include placeholder content for the control so a user can better customize and visualize the final rendering of the control. The placeholder content may later be updated or replaced when a Web application hosting the control executes. In addition, the template schema 202 may include style options for formatting the structural representation and/or the content of the control. In exemplary embodiments of the invention, as shown in FIG. 2, the template schema section 202 includes one or more template schema elements, such as schema element A (206) and schema element B (208).

In embodiments of the invention, unlike templates created by the conventional templating mechanism such as described in the Background section that presents only a fragment of the user interface of the final rendering of the control, the template schema section 202 in the semantically complete template 200 defines the overall user interface of the final rendering of the control and/or the content of the control. Therefore, a Web designer or a Web developer can visualize the full representation structure of the control by viewing the template schema section 202.

In embodiments of the invention, the semantically complete template 200 also may include a template behavior section 204 that defines custom behavior of the control, supplied by, for example, a developer for the control. For example, if the template schema section 202 defines the layout of a table, a row in the table, and a cell in the table, the corresponding template behavior section 204 for the control may define how the table is arranged in terms of the row and the cell and how content in the table is enumerated cell by cell or row by row. In exemplary embodiments of the invention, the template behavior section 204 may contain one or more behavior elements such as behavior element I (210) and behavior element II (212). A behavior element in the template behavior section 208 may reference a schema element in the template schema section 202, for example, to define the custom behavior for the control with respect to the schema element, to infer at runtime of the control what the layout, appearance, and/or content of the control is.

In exemplary embodiments of the invention, though the template schema section 202 and the template behavior section 204 have distinct functionalities, their content may be separated from each other, as illustrated in FIGS. 2-4, or intertwined with each other. For example, the template behavior section 204 may host the content of the template schema section 202, and vise versa.

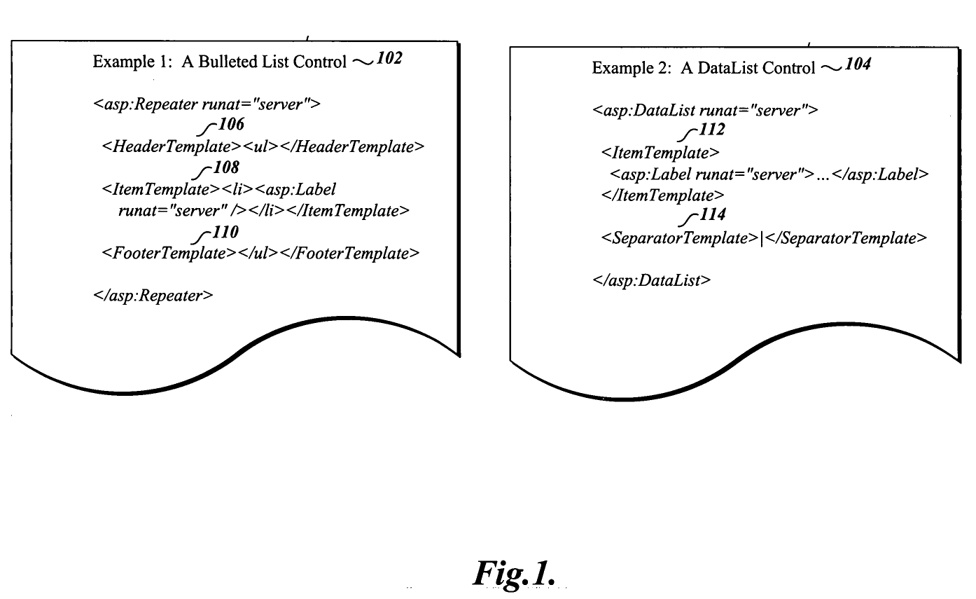

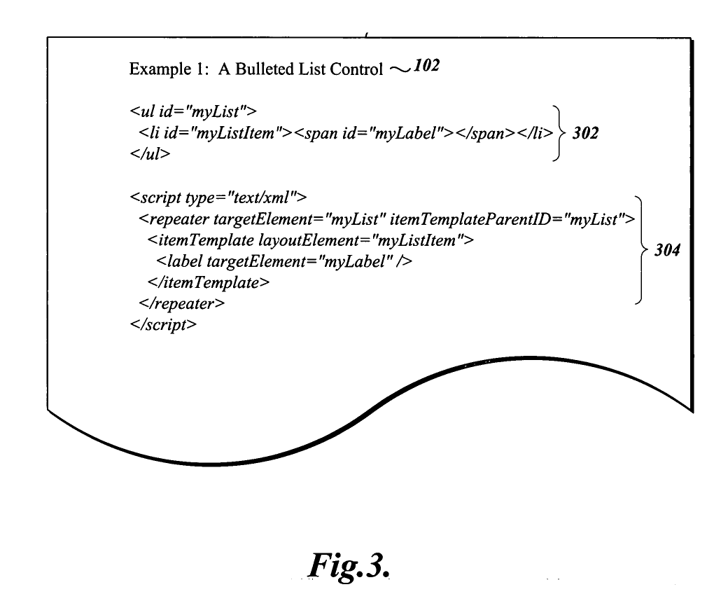

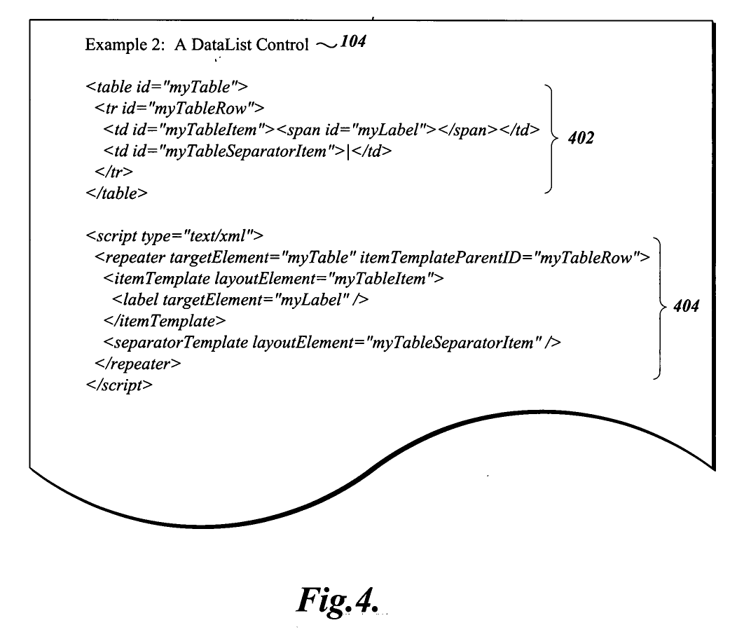

Using concepts of the exemplary semantically complete template 200 illustrated in FIG. 2, both the exemplary controls illustrated in FIG. 1 can be implemented in a way such that they can be designed and viewed independently. FIG. 3 illustrates an exemplary semantically complete template 300 for the Bulleted List Control 102. FIG. 4 illustrates an exemplary semantically complete template 400 for the DataList Control 104. In embodiments of the invention, a semantically complete template may be implemented in a tag-delimited language such as HTML and XML.

As illustrated in FIG. 3, the Bulleted List Control 102 stands on its own as a complete and independent list element. The template schema section 302 may be defined by a Web designer. The template behavior section 304 details an exemplary repeater and may be defined by a Web developer. Thus, a Web designer can design and preview independently the overall presentation of a control. Furthermore, since the template schema section 302 uses a plain markup language such as HTML, the Web designer can also apply styles and even add sample content (may be replaced when the Web application hosting the control is run) to fully customize and visualize the rendering of the Bulleted List Control 102. The Web designer may then hand the template schema section 302 over to a Web developer. The Web developer can define separately the repetition behavior for the Bulleted List Control 102 in the template behavior section 304. As shown in FIG. 3, the template behavior section 304 references template schema elements in the template schema section 302 as the repeated contents or container for the contents.

FIG. 4 illustrates an exemplary semantically complete template 400 for the DataList Control 104. As shown in FIG. 4, the DataList Control 104 now is complete in itself: Its entire structure can be seen, customized, and previewed independently in the template schema section 402 and the template behavior section 404.

In order to define behaviors of a control outside its template schema, exemplary embodiments of the invention attach various forms of identifiers such as style class names or IDs to the template schema section of a control to identify the schema elements in the template schema. A developer defining custom behavior for the control may then reference the identified elements in the template schema section. For example, as shown in FIG. 3, the template behavior section 304 for the Bulleted List Control 102 references schema elements such as “myList”, “myListItem,” and “myLabel” identified in the template schema section 302. Similarly, as shown in FIG. 4, the repeater defined in the template behavior section 404 references schema elements such as “myTable,” “myTableRow,” “myTableItem,” and “myTableSeparatorItem” identified in the template schema section 402.

Embodiments of the invention thus allow a Web designer to define template schema for a control that specifies the overall structure and/or content for final rendering of the control. Embodiments of the invention also allow a Web developer to independently define behavior of the control outside the template schema, for example, by referencing schema elements identified in the template schema.

Although aspects of the invention have been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The embodiments of the invention in which an exclusive property or privilege is claimed are defined as follows:

1. A semantically complete template for defining a user interface control (“control”), comprising:
a template schema section defining overall structure of the control; and
a template behavior section defining custom behavior of the control.

2. The template of claim 1, wherein the template schema section further includes content of the control.

3. The template of claim 2, wherein the content is updated during runtime usage of the control.

4. The template of claim 1, wherein the template schema section includes one or more style options for defining format of the control.

5. The template of claim 1, wherein the template schema section includes one or more template schema elements.

6. The template of claim 5, wherein the template behavior section references at least one of the one or more template schema elements.

7. The template of claim 1, wherein content of the template schema section and the template behavior section are mixed with each other.

8. The template of claim 1, wherein the template is stored on a computer-readable medium.
